(19) United States
(12) Patent Application Publication
(10) Pub. No.: US 2013/0215346 A1
(43) Pub. Date: Aug. 22, 2013

(54) LIQUID CRYSTAL DISPLAY

(71) Applicants: Gak Seok LEE, Cheonan-si (KR); Hee Seop KIM, Suwon-si (KR); Ki Chul SHIN, Suwon-si (KR); Ki-Han KIM, Changwon-si (KR); Byung Wok PARK, Geumjeong-gu (KR); Tae-Hoon YOON, Haewoondae-gu (KR); Eun Young JEON, Nam-gu (KR); Ji-Hoon LEE, Suwon-si (KR)

(72) Inventors: Gak Seok LEE, Cheonan-si (KR); Hee Seop KIM, Suwon-si (KR); Ki Chul SHIN, Suwon-si (KR); Ki-Han KIM, Changwon-si (KR); Byung Wok PARK, Geumjeong-gu (KR); Tae-Hoon YOON, Haewoondae-gu (KR); Eun Young JEON, Nam-gu (KR); Ji-Hoon LEE, Suwon-si (KR)

(73) Assignees: Pusan National University Industry-University Cooperation Foundation, Geumjeong-gu (KR); SAMSUNG DISPLAY CO., LTD., Yongin-City (KR)

(21) Appl. No.: 13/562,142

(22) Filed: Jul. 30, 2012

(30) Foreign Application Priority Data
Feb. 22, 2012 (KR) 10-2012-0017917

(51) Int. Cl. C09K 19/02; G02F 1/1337; G02F 1/136

(52) U.S. Cl. 349/42; 349/182; 349/123; 977/773; 977/950

(57) ABSTRACT

A liquid crystal display is provided. A liquid crystal display according to an exemplary embodiment of the present invention includes a first substrate, a second substrate facing the first substrate, and a liquid crystal layer interposed between the first substrate and the second substrate, wherein the liquid crystal layer includes liquid crystal molecules and nanoparticles including a hydrophobic group having a chain structure and a hydrophilic group.

### CROSS-REFERENCE TO RELATED APPLICATION

This application claims priority to and the benefit of Korean Patent Application No. 10-2012-0017917 filed in the Korean Intellectual Property Office on Feb. 22, 2012, the entire contents of which are incorporated herein by reference.

### BACKGROUND OF THE INVENTION

(a) Field of the Invention The present invention generally relate to a liquid crystal display.

(b) Description of the Related Art

In general, liquid crystal displays include an upper panel formed with a common electrode, a lower panel formed with a thin film transistor and a pixel electrode, and a liquid crystal material injected therebetween. Different electric potentials are applied to the pixel electrode and the common electrode to form an electric field such that an arrangement of liquid crystal molecules is changed, thereby displaying an image by controlling transmittance of light.

Among them, a vertical alignment (VA) mode liquid crystal display offers the highest contrast ratio. In a VA mode liquid crystal display, the liquid crystal molecules are arranged such that long axes thereof are realigned vertically to the upper and the lower panels in the absence of the electric field. In the vertical alignment (VA) mode liquid crystal display, to form a vertical alignment layer, an alignment layer is coated on the transparent electrode corresponding to the pixel electrode or the common electrode. A baking process is performed after coating the alignment layer such that process cost and time are increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a liquid crystal display in which liquid crystal molecules are vertically aligned without an alignment layer.

A liquid crystal display according to an exemplary embodiment of the present invention includes: a first substrate; a second substrate facing the first substrate; and a liquid crystal layer interposed between the first substrate and the second substrate, wherein the liquid crystal layer includes liquid crystal molecules and nanoparticles including a hydrophobic group having a chain structure and a hydrophilic group.

The hydrophobic group having a chain structure may include a hydrocarbon chain, wherein the hydrocarbon chain may have two end portions, and the hydrophilic group is positioned at one of the two end portions.

A thin film transistor positioned on the first substrate and a field generating electrode connected to the thin film transistor may be further included, wherein the hydrophilic group of the nanoparticle may be positioned adjacent to the field generating electrode.

The hydrocarbon chain may extend vertically to the field generating electrode.

The liquid crystal molecules may be positioned adjacent to the end portion positioned at an opposite side to the end portion where the hydrophilic group is positioned, and the liquid crystal molecules may be vertically aligned in a state that an electric field is not applied to the field generating electrode.

The nanoparticles may include HTAB (hexadecyl trimethyl ammonium bromide).

The nanoparticle may be included in a range of equal to or more than about 0.01 wt % and equal to or less than about 0.05 wt % in the liquid crystal layer.

A field generating electrode positioned on the first substrate and an alignment layer positioned between the field generating electrode and the liquid crystal layer may be further included.

The field generating electrode may include a plurality of minute branches.

The alignment layer may include the nanoparticles including the hydrophobic group having the chain structure, and the hydrophilic group.

At least one of the liquid crystal layer and the alignment layer may further include an alignment polymer.

The nanoparticles included in the at least one of the liquid crystal layer and the alignment layer may include the hydrocarbon chain, the hydrocarbon chain may have two end portions, and the hydrophilic group is attached to one of the two end portions.

A thin film transistor positioned on the first substrate and a field generating electrode connected to the thin film transistor may be included, wherein the hydrophilic group of the nanoparticles may be positioned adjacent to the field generating electrode.

The hydrocarbon chain may extend in a direction substantially vertical to the field generating electrode.

The liquid crystal molecules may be positioned adjacent to the end portion positioned at an opposite side to the end portion where the hydrophilic group is positioned, and the liquid crystal molecules may be vertically aligned in a state that an electric field is not applied to the field generating electrode.

A liquid crystal display according to an exemplary embodiment of the present invention includes a first substrate, a second substrate facing the first substrate, and a liquid crystal layer interposed between the first substrate and the second substrate, wherein the liquid crystal layer includes liquid crystal molecules and nanoparticles represented by Formula 1 below.

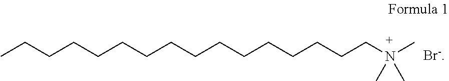

A thin film transistor positioned on the first substrate, a field generating electrode connected to the thin film transistor, and a hydrophobic group of the nanoparticle may be further included, wherein a hydrophilic group of the nanoparticles may be positioned adjacent to the field generating electrode.

In the nanoparticles, a hydrocarbon chain may extend in a direction substantially vertical to the field generating electrode, the liquid crystal molecules may be positioned adjacent to the hydrocarbon chain, and the liquid crystal molecules may be vertically aligned in a state that the electric field is not applied to the field generating electrode.

As described above, according to an exemplary embodiment of the present invention, the liquid crystal molecules and the nanoparticles are mixed in the liquid crystal layer such that the liquid crystal molecules may be vertically aligned without the alignment layer.

### BRIEF DESCRIPTION OF THE DRAWINGS

FIG. 1 is a top plan view of a liquid crystal display according to an exemplary embodiment of the present invention.

FIG. 2 is a cross-sectional view taken along the line II-II′ of FIG. 1.

FIG. 3 is a top plan view of a liquid crystal display according to an exemplary embodiment of the present invention.

FIG. 4 is a cross-sectional view taken along the line IV-IV′ of FIG. 3.

FIG. 5 and FIG. 6 are respectively a top plan view of a pixel electrode and a base electrode in the exemplary embodiment of FIG. 3.

FIG. 7 is a schematic diagram of a liquid crystal layer according to an exemplary embodiment of the present invention.

FIG. 8 and FIG. 9 are plane photographs of a state in which liquid crystal molecules are finally aligned in the absence of a voltage and with application of a driving voltage in a liquid crystal display of a comparative example and an exemplary embodiment of the present invention.

FIG. 10 and FIG. 11 are graphs showing transmittance and response time according to a voltage in Comparative Example 1 and Exemplary Embodiment 1.

FIG. 12 and FIG. 13 are graphs showing transmittance and response time according to a voltage in Comparative Example 2 and Exemplary Embodiment 2.

### DETAILED DESCRIPTION OF THE EMBODIMENTS

Exemplary embodiments of the present invention will be described in detail with reference to the accompanying drawings. However, the present invention is not limited to the exemplary embodiments described herein, and may be embodied in other forms. Exemplary embodiments described herein are provided to thoroughly and completely understand the disclosed contents and to sufficiently transfer the ideas of the present invention to a person of ordinary skill in the art.

In the drawings, the thicknesses of layers and regions are exaggerated for clarity. It is to be noted that when a layer is referred to as being “on” another layer or substrate, it can be directly formed on the other layer or substrate or can be formed on the other layer or substrate with a third layer interposed therebetween. Like constituent elements are denoted by like reference numerals throughout the specification.

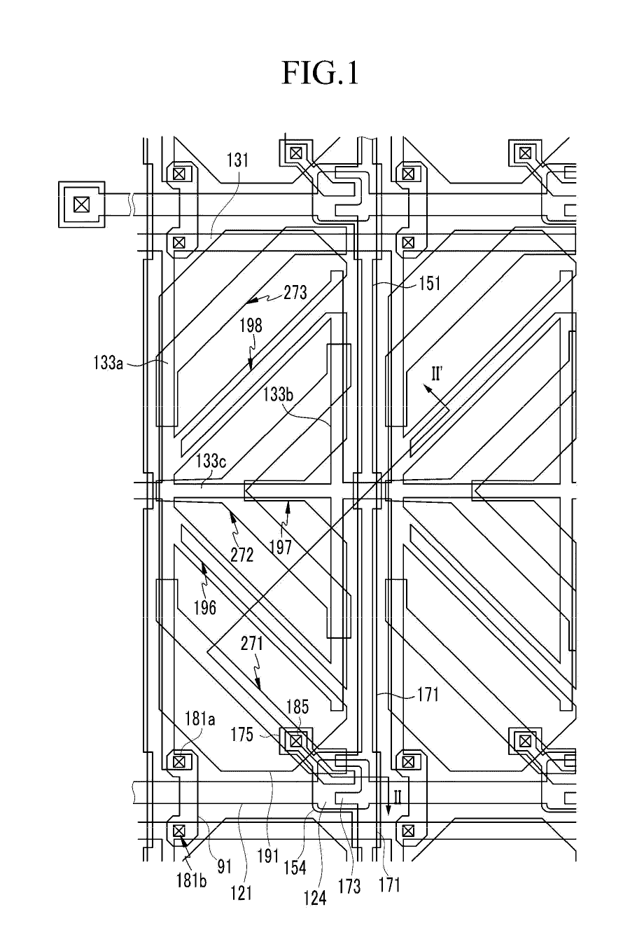

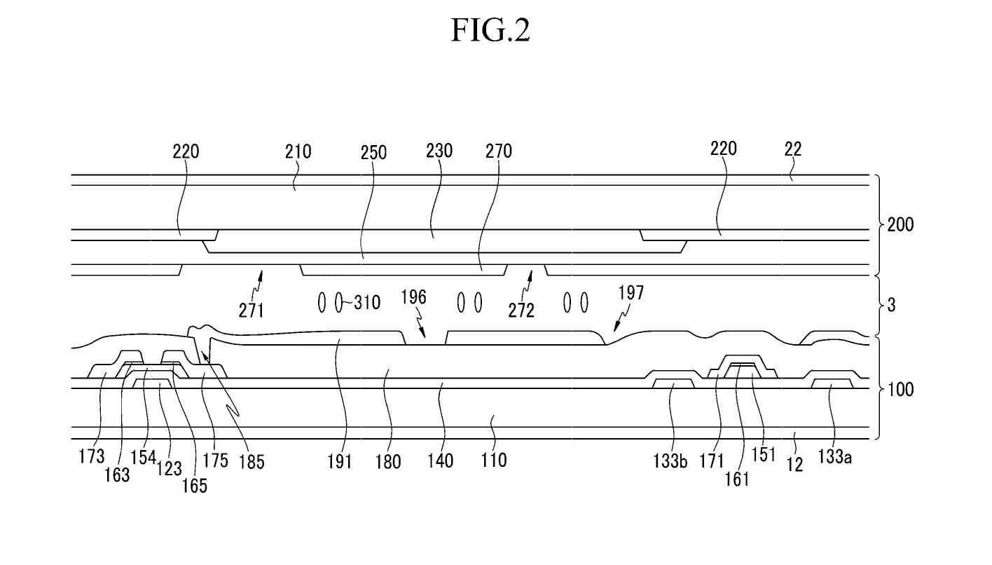

FIG. 1 is a top plan view of a liquid crystal display according to an exemplary embodiment of the present invention. FIG. 2 is a cross-sectional view taken along the line II-II′ of FIG. 1.

Referring to FIG. 1 and FIG. 2, a liquid crystal display according to the present exemplary embodiment includes a lower panel 100 (a thin film transistor array panel), an upper panel 200 (a common electrode panel) facing the lower panel 100, and a liquid crystal layer 3 interposed therebetween. The liquid crystal layer includes liquid crystal molecules 310 aligned almost perpendicularly to the surface of the two display panels 100 and 200 and nanoparticles (not shown) including a hydrophobic group and a hydrophilic group having a chain structure.

A plurality of gate lines 121 and a plurality of storage electrode lines 131 are formed on an insulation substrate 110 made of transparent glass.

The gate lines 121 mainly extending in a transverse direction are separated from each other and transmit a gate signal. Each gate line 121 has a plurality of protrusions forming a gate electrode 124.

Each storage electrode line 131 mainly extends in the transverse direction and includes first to third storage electrodes 133a, 133b, and 133c. The first storage electrode 133a and the second storage electrode 133b extend in the longitudinal direction, and the third storage electrode 133c extends in the transverse direction and connects the first storage electrode 133a and the second storage electrode 133b. The first storage electrode 133a has a free end and a fixing end connected to the storage electrode line 131, and the free end has a protrusion. The third storage electrode 133c forms a center line of two neighboring gate lines 121. The storage electrode line 131 is applied with a predetermined voltage such as a common voltage applied by a common electrode 270 of the upper panel 200 of the liquid crystal display. Each storage electrode line 131 may include a pair of stems extending in the transverse direction of a pixel area.

The gate line 121 and the storage electrode line 131 may be made of a material selected from an aluminum-based metal such as aluminum (Al) and aluminum alloys, a silver-based metal such as silver (Ag) and silver alloys, and a copper-based metal such as copper (Cu) and copper alloys.

In the present exemplary embodiment, the gate line 121 and the storage electrode line 131 are formed with a single layer; however, it is not limited thereto and they may be formed with a dual layer or a triple layer.

In a case of the dual-layer structure, the gate line 121 and the storage electrode line 131 may include a lower layer and an upper layer, and the lower layer may be made of one selected from a molybdenum-based metal such as molybdenum (Mo) and molybdenum alloys, chromium (Cr), a chromium alloy, titanium (Ti), a titanium alloy, tantalum (Ta), a tantalum alloy, manganese (Mn), and a manganese alloy. The upper layer may be made of one selected from an aluminum-based metal such as aluminum (Al) and aluminum alloys, a silver-based metal such as silver (Ag) and silver alloys, and a copper-based metal such as copper (Cu) and copper alloys. In a case of the triple-layer structure, they may be made of a combination having different physical properties.

A gate insulating layer 140 made of silicon nitride is formed on the gate line 121 and the storage electrode line 131.

A plurality of semiconductor stripes 151 made of hydrogenated amorphous silicon or polysilicon are formed on the gate insulating layer 140. The semiconductor stripe 151 extends mainly in the longitudinal direction and includes a plurality of protrusions 154 extending therefrom toward the gate electrodes 124.

A plurality of ohmic contact stripes 161 and ohmic contact islands 165 made of silicide or a material such as n+ hydrogenated amorphous silicon doped with an n-type impurity of a high concentration are formed on the semiconductor 151. The ohmic contact stripe 161 has a plurality of ohmic contact protrusions 163. An ohmic contact protrusion 163 and an ohmic contact island 165 are positioned as a pair on a protrusion 154 of the semiconductor 151.

A plurality of data lines 171 and a plurality of drain electrodes 175 separated therefrom are formed on the ohmic contact stripes 161 and ohmic contact islands 165 respectively.

The data lines 171 extending in the main longitudinal direction intersect the gate lines 121 and the storage electrode lines 131 and transmit a data voltage. Each data line 171 is positioned between a first storage electrode 133a and a second storage electrode 133b. Each data line 171 has a plurality of branches forming a source electrode 173 facing the drain electrode 175. One end of each drain electrode 175 has a wide area for connection with other layers, and each source electrode 173 is curved to enclose the other end of the drain electrode 175.

The gate electrode 124, the source electrode 173, and the drain electrode 175 form a thin film transistor as a switching element along with the protrusion of the semiconductor 151. A channel of the thin film transistor is formed in the protrusion 154 of the semiconductor 151 between the source electrode 173 and the drain electrode 175.

The data line 171 and the drain electrode 175 may be made of one selected from an aluminum-based metal such as aluminum (Al) and aluminum alloys, a silver-based metal such as silver (Ag) and silver alloys, and a copper-based metal such as copper (Cu) and copper alloys.

In the present exemplary embodiment, the data line 171, the source electrode 173, and the drain electrode 175 are formed with a single layer. However this is not a limitation and the elements may be formed with a dual layer or a triple layer.

In the dual-layer structure, the data line 171, the source electrode 173, and the drain electrode 175 may include a lower layer and an upper layer, and the lower layer may be made of one selected from a molybdenum-based metal such as molybdenum (Mo) and molybdenum alloys, chromium (Cr), a chromium alloy, titanium (Ti), a titanium alloy, tantalum (Ta), a tantalum alloy, manganese (Mn), or a manganese alloy, and the upper layer may be made of one selected from an aluminum-based metal such as aluminum (Al) and aluminum alloys, a silver-based metal such as silver (Ag) and silver alloys, and a copper-based metal such as copper (Cu) and copper alloys. In a case of the triple-layer structure, they may be made of a combination having different physical properties.

The ohmic contact stripes 161 and ohmic contact islands 165 exist between the underlying semiconductor 151 and overlying data line 171 and drain electrode 175, and reduce contact resistance therebetween. The semiconductor stripe 151 has a portion that is not covered by the data line 171 and the drain electrode 175 such as a portion between the source electrode 173 and the drain electrode 175.

A passivation layer 180 is formed on the data line 171, the drain electrode 175, and the exposed semiconductor 151. The passivation layer 180 may be formed of an organic material having an excellent flatness characteristic, excellent photosensitivity, and a low dielectric constant of less than 4.0, or an inorganic material such as silicon nitride.

The passivation layer 180 has a plurality of contact holes 185 exposing the end of the drain electrode 175. The gate insulating layer 140 and the passivation layer 180 have contact holes 181a and 181b respectively exposing the protrusion of the free end of the first storage electrode 133a and a portion of the storage electrode line 131 close to the fixing end of the first storage electrode 133a.

A plurality of pixel electrodes 191 and a connection bridges 91 of a plurality of storage electrode lines made of ITO or IZO are formed on the passivation layer 180.

The pixel electrode 191 is electrically connected to the drain electrode 175 through the contact hole 185, thereby receiving a data voltage from the drain electrode 175.

The pixel electrode 191 applied with the data voltage forms the electric field along with the common electrode 270 applied with the common voltage such that the liquid crystal molecules of the liquid crystal layer 3 between the two electrodes 191 and 270 are rearranged.

The liquid crystal layer 3 of the liquid crystal display according to the present exemplary embodiment includes liquid crystal molecules and nanoparticles in a chain having a hydrophobic group and a hydrophilic group. For example, the chain may be a hydrophobic chain. In detail, in the present exemplary embodiment, as represented by Formula 1, the nanoparticles include the hydrophobic group including a hydrocarbon having the chain structure and the hydrophilic group in which nitrogen ions (N+) and bromide ions (Br−) are ion-bonded. The hydrocarbon having the chain structure has two end portions, and the hydrophilic group is positioned at one of the two end portions. Here, the hydrophilic group of the nanoparticle is positioned adjacent to the pixel electrode 191 or the common electrode 270, and the hydrophobic group having the chain structure may be substantially arranged in the direction perpendicular to the pixel electrode 191 or the common electrode 270. In detail, the hydrophilic group of the nanoparticle is positioned adjacent to the pixel electrode 191 or the common electrode 270 such that the hydrocarbon having the chain structure is arranged in the vertical direction, and the hydrocarbon having the chain structure functions as an alkyl chain of the typical vertical alignment layer such that the liquid crystal molecules are arranged in the vertical direction.

In the present exemplary embodiment, equal to or more than about 0.01 wt % to equal to or less than about 0.05 wt % of the nanoparticles may be included in the liquid crystal layer 3. According to an experimental result, when the amount of the nanoparticles included in the liquid crystal layer 3 is equal to or more than 0.01 wt %, the liquid crystal molecules are vertically aligned, and when the nanoparticles are included at 0.1 wt % which is greater than the upper range of 0.05 wt % in the liquid crystal layer 3, the particles are condensed, thereby generating light leakage. Accordingly, in the present exemplary embodiment, the content of the nanoparticles is preferably equal to or more than 0.01 wt % and equal to or less than 0.05 wt % in the liquid crystal layer 3.

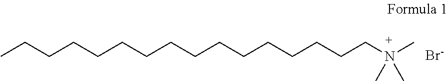

In general, in the vertical alignment (VA) mode liquid crystal display, to initially align the liquid crystal molecule of the liquid crystal layer 3 vertically, alignment layers are formed on the pixel electrode 191 or the common electrode 270. However, in the liquid crystal display according to an exemplary embodiment of the present invention, the liquid crystal material is injected between the pixel electrode 191 and the common electrode 270 without the alignment layers thereby forming the liquid crystal layer 3.

The pixel electrode 191, the common electrode 270 and the liquid crystal layer 3 injected therebetween form a liquid crystal capacitor to maintain the voltage applied to the liquid crystal layer even after the thin film transistor is turned off. To enhance the voltage maintaining capacity, a storage capacitor coupled in parallel to the liquid crystal capacitor is formed. The storage capacitor is formed by overlapping the pixel electrode 191 and the storage electrode line 131 including the storage electrodes 133a, 133b, and 133c.

Each pixel electrode 191 is chamfered at four corners, and the chamfered edge forms an angle of about 45° with respect to the gate line 121.

The pixel electrode 191 has a lower cutout 196, a center cutout 197, and an upper cutout 198, and the pixel electrode 191 is divided into a plurality of regions by the cutouts 196, 197, and 198. The cutouts 196, 197, and 198 are approximately symmetrical with respect to the third storage electrode 133c.

The lower and upper cutouts 196 and 198 are approximately obliquely inclined from the right edge of the pixel electrode 191 to the left edge, and are respectively disposed on the lower-half portion and the upper-half portion with respect of the pixel electrode 191 divided by the third storage electrode 133c. The lower and upper cutouts 196 and 198 are inclined with respect to the gate line 121 by an angle of about 45°, and extend perpendicularly to each other.

The central cutout 197 extends along the third storage electrode 133c and has an inlet from the right edge of the pixel electrode 191. The inlet of the central cutout 197 has a pair of inclined edges substantially parallel to the oblique portions of the lower and upper cutouts 196 and 198.

Accordingly, the lower half of the pixel electrode 191 is partitioned into two lower portions by the lower cutout 196, and the upper half of the pixel electrode 191 is partitioned into two upper portions by the upper cutout 198. The number of portions and the number of cutouts can be varied depending on design factors such as the size of pixels, the ratio of the transverse edges and the longitudinal edges of the pixel electrodes, the type and characteristics of the liquid crystal layer 3, and so on.

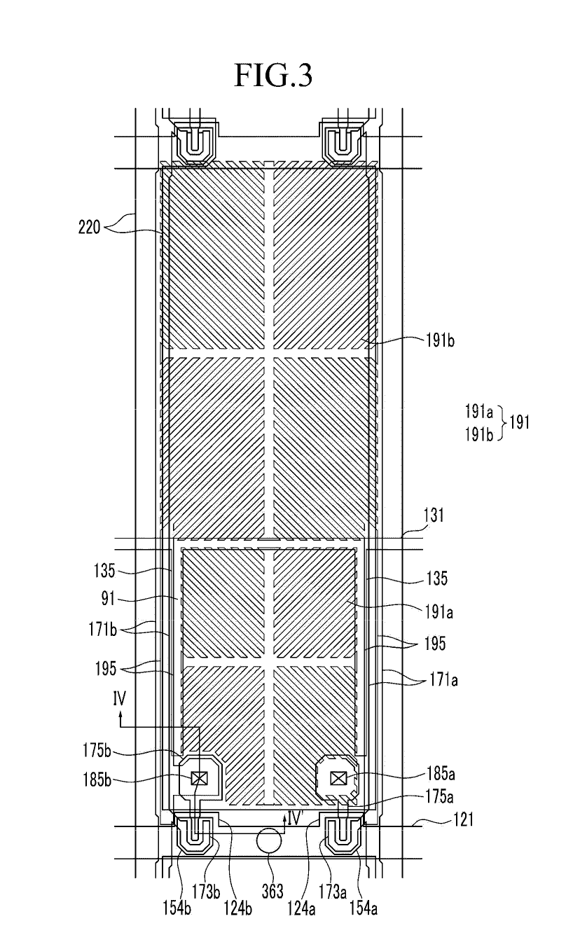

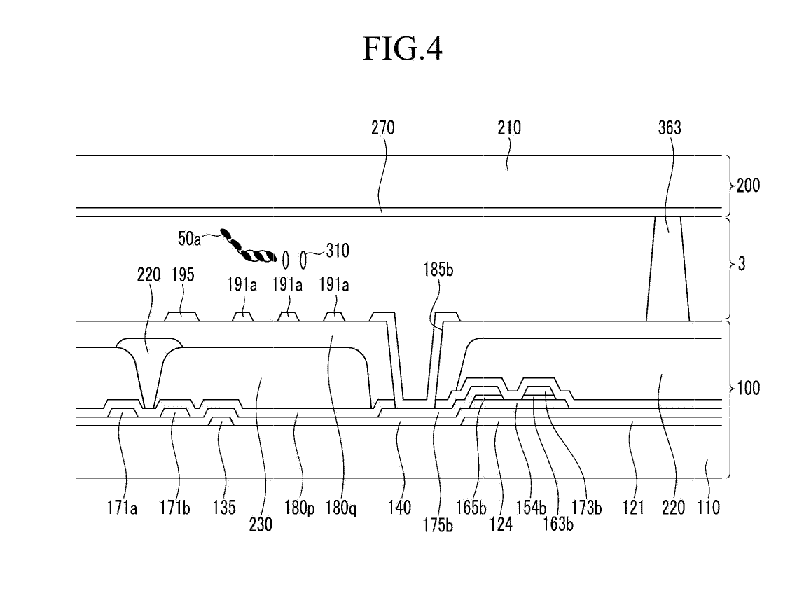

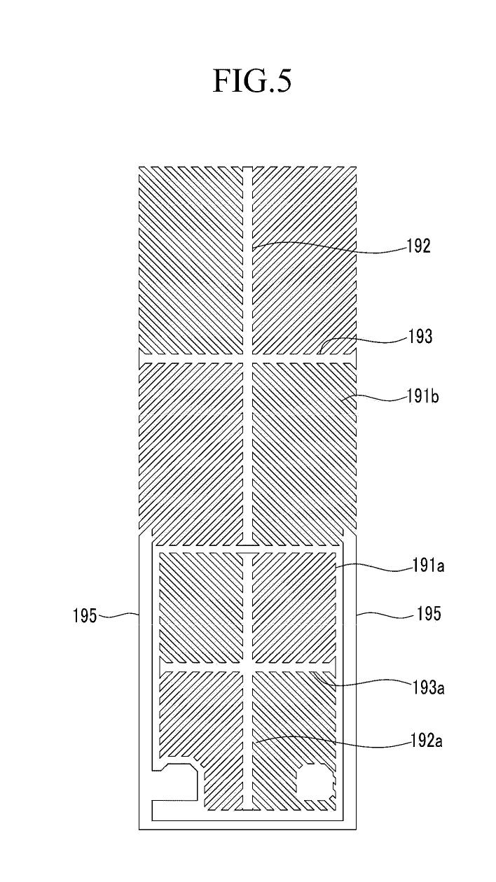

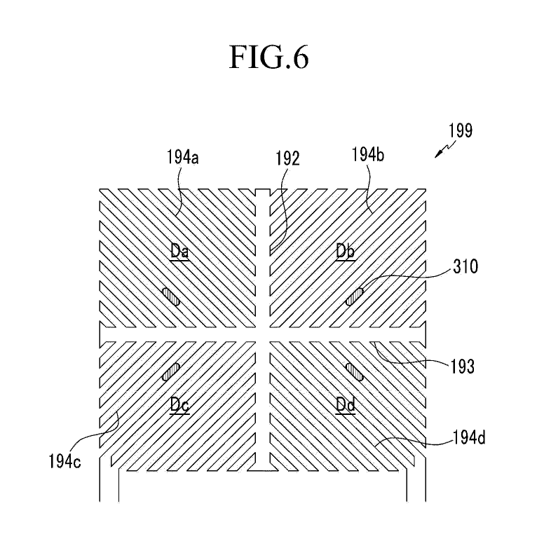

FIG. 3 is a top plan view of a liquid crystal display according to another exemplary embodiment of the present invention. FIG. 4 is a cross-sectional view taken along the line IV-IV′ of FIG. 3. FIG. 5 and FIG. 6 are respectively a top plan view of a pixel electrode and a base electrode in the exemplary embodiment of FIG. 3.

Referring to FIG. 3 and FIG. 4, a liquid crystal display according to an exemplary embodiment of the present invention includes a lower panel 100 and an upper panel 200 facing each other, and a liquid crystal layer 3 interposed therebetween.

First, the lower panel 100 will be described.

A plurality of gate lines 121 and a plurality of storage electrode lines 131 and 135 are formed on an insulation substrate 110.

The gate lines 121 transmit gate signals and substantially extend in the transverse direction. Each gate line 121 includes a plurality of first and second gate electrodes 124a and 124b protruding upward.

The storage electrode lines 131 include a stem 131 extending substantially parallel to the gate lines 121, and a plurality of storage electrodes 135 extended from the stem. However, the shapes and arrangement of the storage electrode lines 131 and 135 may be modified in various forms.

A gate insulating layer 140 is formed on the gate lines 121 and the storage electrode lines 131 and 135, and a plurality of semiconductors 154a and 154b preferably made of amorphous or crystallized silicon are formed on the gate insulating layer 140.

A pair of ohmic contacts 163b and 165b are formed on the semiconductor 154a and 154b, and the ohmic contacts 163b and 165b may be formed of a material such as n+ hydrogenated amorphous silicon in which an n-type impurity is doped with a high concentration, or of silicide.

A plurality of pairs of data lines 171a and 171b and a plurality of pairs of first and second drain electrodes 175a and 175b are formed on the ohmic contacts 163b and 165b, and on the gate insulating layer 140.

The data lines 171a and 171b transmit data signals, extend substantially in the longitudinal direction, and cross the gate lines 121 and the stem of the storage electrode lines 131. Each data line 171a/171b includes a plurality of first/second source electrodes 173a/173b extending toward the first/second gate electrodes 124a/124b and curved with a “U” shape, and the first/second source electrodes 173a/173b are opposite to the first/second drain electrodes 175a/175b with respect to the first/second gate electrodes 124a/124b.

Each of the first and second drain electrodes 175a and 175b starts from one end enclosed by the first source electrode 173a, and extends upward, and the other end of the first and second drain electrodes 175a and 175b may have a wide area for connection with another layer.

However, the shapes and arrangement of the first and second drain electrodes 175a and 175b and the data lines 171a and 171b may be modified in various forms.

A first/second gate electrode 124a/124b, a first/second source electrode 173a/173b, and a first/second drain electrode 175a/175b respectively form a first/second thin film transistor (TFT) Qa/Qb along with a first/second semiconductor 154a/154b, and a channel of the first/second thin film transistor Qa/Qb is formed on the first/second semiconductor 154a/154b between the first/second source electrode 173a/173b and the first/second drain electrode 175a/175b.

The ohmic contacts 163b and 165b are interposed between the underlying semiconductor islands 154a and 154b, and the overlying data lines 171a and 171b and drain electrodes 175a and 175b, and reduce contact resistance between them. The semiconductors 154a and 154b have a portion that is exposed without being covered by the data lines 171a and 171b and the drain electrodes 175a and 175b, and a portion between the source electrodes 173a and 173b and the drain electrodes 175a and 175b.

A lower passivation layer 180p preferably made of silicon nitride or silicon oxide is formed on the data lines 171a and 171b, the drain electrodes 175a and 175b, and the exposed portions of the semiconductors 154a and 154b.

A color filter 230 is formed on the lower passivation layer 180p. The color filter 230 may include three color filters of red, green, and blue. A light blocking member 220 made of a single layer or double layers such as chromium and chromium oxide or an organic material is formed on the color filter 230. The light blocking member 220 may have openings arranged in a matrix.

An upper passivation layer 180q made of a transparent organic insulating material is formed on the color filter 230 and the light blocking member 220. The upper passivation layer 180q prevents the color filter 230 from being exposed and provides a flat surface. The upper passivation layer 180q has a plurality of contact holes 185a and 185b exposing the first and second drain electrodes 175a and 175b.

A plurality of pixel electrodes 191 are formed on the upper passivation layer 180q. The pixel electrodes 191 may be formed with a transparent conductive material such as ITO and IZO, or with a reflective material such as aluminum, silver, chromium, and alloys thereof.

The respective pixel electrodes 191 include first and second sub-pixel electrodes 191a and 191b separated from each other, and the first and second sub-pixel electrodes 191a and 191b include electrodes like a basic electrode 199 shown in FIG. 6 or variants thereof.

The basic electrode 199 will now be described in detail with reference to FIG. 5 and FIG. 6.

As shown in FIG. 6, the basic electrode 199 is wholly quadrangular-shaped, and has a cross-shaped stem portion with transverse and longitudinal stems 193 and 192 extending perpendicular to each other. Furthermore, the basic electrode 199 is partitioned into first to fourth sub-regions Da, Db, Dc, and Dd by way of the transverse and longitudinal stems 193 and 192, and the sub-regions Da to Dd have a plurality of first to fourth minute branches 194a, 194b, 194c, and 194d, respectively.

The first minute branch 194a extends from the transverse stem 193 or the longitudinal stem 192 toward the top left while being tilted, and the second minute branch 194b extends from the transverse stem 193 or the longitudinal stem 192 toward the top right in a tilted manner. The third minute branch 194c extends from the transverse stem 193 or the longitudinal stem 192 toward the bottom left in a tilted manner, and the fourth minute branch 194d extends from the transverse stem 193 or the longitudinal stem 192 toward the bottom right in a tilted manner.

The first to fourth minute branches 194a to 194d are angled to the gate line 121 or the transverse stem 193 by about 45 or 135 degrees. Furthermore, the minute branches 194a to 194d of two neighboring sub-regions Da to Dd may extend perpendicularly to each other.

The width of the minute branches 194a to 194d may be in the range of 2.0 μm to 5.0 μm, and the interval between the neighboring minute branches 194a to 194d of one of sub-regions Da-Dd may be in the range of 2.5 μm to 5.0 μm.

Although not shown in the drawing, the widths of the minute branches 194a to 194d may be enlarged when coming closer to the transverse stem 193 or the longitudinal stem 192.

Referring to FIG. 3 to FIG. 6 again, the first and second sub-pixel electrodes 191a and 191b each include one basic electrode 199. The area of the second sub-pixel electrode 191b in the whole pixel electrode 191 may be larger than the area of the first sub-pixel electrode 191a, and in this case, the second sub-pixel electrode 191b is differentiated in size of the basic electrode 199 such that the area thereof is larger than the area of the first sub-pixel electrode 191a by 1.0 to 2.2 times.

The second sub-pixel electrode 191b includes a pair of branches 195 extending according to the data line 171. The branches 195 are disposed between the first sub-pixel electrode 191a and the data lines 171a and 171b, and are connected each other at the bottom of the first sub-pixel electrode 191a. The first and second sub-pixel electrodes 191a and 191b are electrically connected to the first and second drain electrodes 175a and 175b through the contact holes 185a and 185b so as to receive data voltages from the first and second drain electrodes 175a and 175b.

The upper display panel 200 will now be described in detail.

With the upper display panel 200, a common electrode 270 is formed on the entire surface of a transparent insulation substrate 210.

Spacers 363 are formed so as to space the upper and lower panels 200 and 100 apart from each other by a predetermined distance.

In general, in the case of the vertical alignment (VA) mode liquid crystal display, the vertical alignment layer is coated on the inner surface of the lower panel 100 and the upper panel 200, however the alignment layer is not formed in the present exemplary embodiment.

Polarizers (not shown) may be provided on the outer surfaces of the lower panel 100 and the upper panel 200.

A liquid crystal layer 3 is interposed between the lower panel 100 and the upper panel 200. In the present exemplary embodiment, the liquid crystal layer 3 includes a plurality of liquid crystal molecules 310, nanoparticles (not shown) including a hydrophobic group having a chain structure and a hydrophilic group, and an alignment polymer 50a formed by irradiating an alignment agent.

The liquid crystal molecules 310 have negative dielectric anisotropy, and they are arranged such that the long axes thereof are aligned vertically to the surface of two display panels 100 and 200 in the absence of an electric field. In the present exemplary embodiment, the nanoparticles including the hydrophobic group having the chain structure and the hydrophilic group are included in the liquid crystal layer 3 such that the liquid crystal molecules 310 may be aligned vertically without the alignment layer. In detail, the hydrophilic group of the nanoparticles is positioned adjacent to the pixel electrode 191 or the common electrode 270 such that the hydrocarbons having the chain structure are arranged in the vertical direction and the hydrocarbons having the chain structure functions as the alkyl chain of a typical vertical alignment layer, thereby arranging the liquid crystal molecules in the vertical direction.

The nanoparticles include hexadecyl trimethyl ammonium bromide (HTAB) represented by Formula 1.

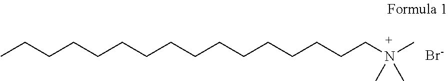

HTAB includes hydrocarbon chain and the hydrophilic group in which nitrogen ions (N+) and bromide ions (Br−) are ion-bonded to the end portion of the hydrocarbon chain.

The hydrocarbon chain has two end portions. The hydrophilic group is bonded at one of two end portions and the liquid crystal molecule 310 is positioned adjacent to the end portion positioned at the other side of the end portion where the hydrophilic group is positioned.

In the present exemplary embodiment, the hexadecyl trimethyl ammonium bromide (HTAB) may be included in the range of equal to or more than about 0.01 wt % and equal to or less than about 0.05 wt % in the liquid crystal layer 3.

If voltages are applied to the pixel electrode 191 and the common electrode 270, the liquid crystal molecules 310 respond to the electric field generated between the pixel electrode 191 and the common electrode 270 such that the long axes thereof tend to become perpendicular to the electric field direction. The change in an inclination degree of the liquid crystal molecules 310 according to an applied voltage between the pixel electrode 191 and the common electrode 270 affects a polarization state of light pass through the liquid crystal layer. This change in polarization state of light results in a change of transmittance of the liquid crystal display, thereby the liquid crystal display device can display images by controlling transmittance of light pass through the liquid display device.

The inclination direction of the liquid crystal molecules 310 is determined by the minute branches 194a-194d of the pixel electrodes 191, and the liquid crystal molecules 310 are inclined in the direction parallel to the length direction of the minute branches 194a-194d. The length directions in which the minute branches 194a-194d are extended in one pixel PX are four directions such that the inclined directions of the liquid crystal molecules 31 are four directions. Thereby, four domains having different inclination directions of the liquid crystal molecules 310 are formed in the liquid crystal layer 3. Therefore, the viewing angle of the liquid crystal display is widened by varying the inclined directions of the liquid crystal molecules.

The alignment polymer 50a formed by polymerization of the alignment supplement agent functions to control a pre-tilt of an initial alignment direction of the liquid crystal 310. The alignment supplement agent may be a reactive mesogen.

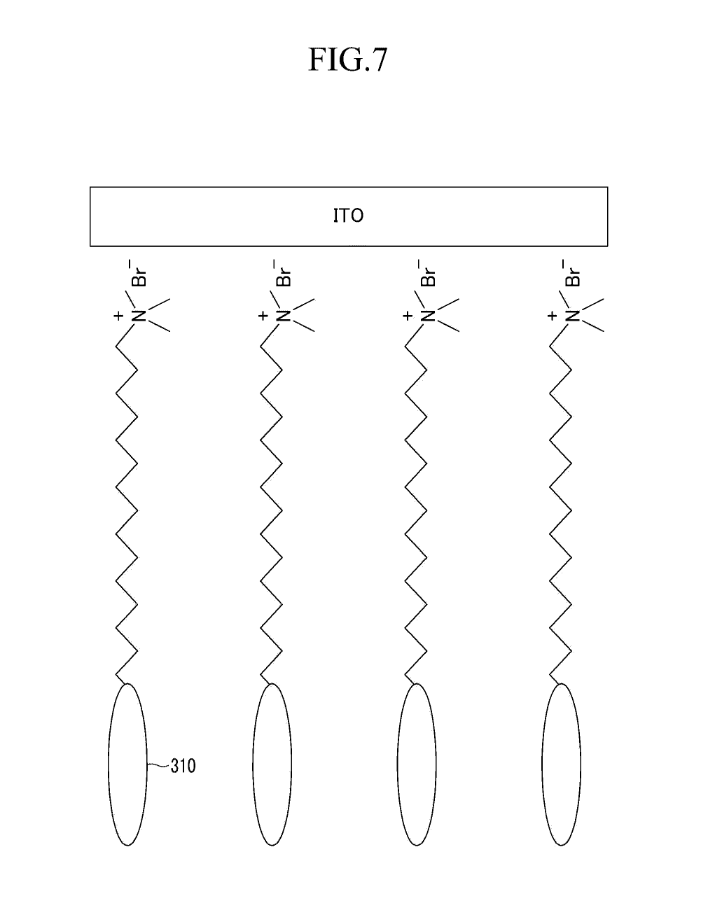

FIG. 7 is a schematic diagram of a liquid crystal layer according to an exemplary embodiment of the present invention.

Referring to FIG. 7, nanoparticles including the hydrophobic group and the hydrophilic group and represented by Formula 1 below are positioned on the transparent electrode made of ITO or IZO.

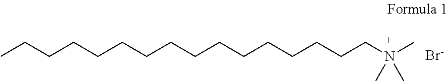

The nanoparticles of the present exemplary embodiment include the hydrophobic group including the hydrocarbon chain extending in the direction substantially vertical to the transparent electrode (ITO) and the hydrophilic group in which the nitrogen ions (N+) and the bromide ions (Br−) are ion-bonded to each other. The hydrophilic group positioned adjacent to the transparent electrode, and the hydrophobic group including the hydrocarbon chain extends in the direction far from the transparent electrode (ITO). Also, the hydrophilic group is positioned at one end portion of two end portions of the hydrocarbon chain, and the liquid crystal molecule 310 is positioned adjacent to the end portion positioned opposite to the end portion where the hydrophilic group is positioned.

The liquid crystal molecules 310 may also be aligned vertically to the transparent electrode (ITO) by the hydrophobic group including the hydrocarbon chain extending vertically to the transparent electrode (ITO).

In the present exemplary embodiment, the nanoparticles are present in the range of equal to or more than about 0.01 wt % and equal to or less than about 0.05 wt % in the liquid crystal layer 3.

Here, the liquid crystal molecules 310 may have negative dielectric anisotropy, however it is not limited thereto, and a material having positive dielectric anisotropy may be used.

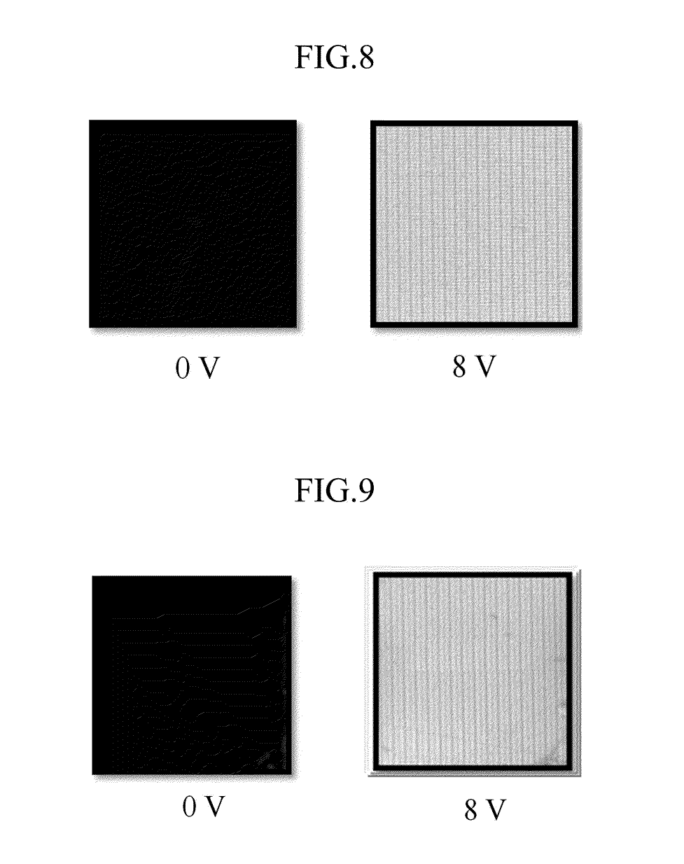

FIG. 8 and FIG. 9 are plane photographs of a state in which liquid crystal molecules are finally aligned in the absence of a voltage and in an application of a driving voltage in a liquid crystal display of a comparative example and an exemplary embodiment of the present invention using formula 1 as a nanoparticles. In detail, FIG. 8 is the plane photograph of a state in which liquid crystal molecules are finally aligned in the absence of a voltage and in an application of a driving voltage in a liquid crystal display using a vertical alignment layer according to a comparative example, and FIG. 9 is the plane photograph of a state in which liquid crystal molecules are finally aligned in the absence of a voltage and in an application of a driving voltage in a liquid crystal display in which the nanoparticles according to the exemplary embodiment described in FIG. 7 of the amount of 0.05 wt % are mixed in the liquid crystal layer. In the exemplary embodiment of FIG. 9, the alignment layer is not formed.

Referring to FIG. 8 and FIG. 9, the display screen is almost the same in the comparative example and the exemplary embodiment in the state 0V in which the voltage is not applied and in the state that the driving voltage 8V is applied. Accordingly, it may be confirmed that the liquid crystal molecules may be vertically aligned without the alignment layer according to an exemplary embodiment of the present invention. Particularly, although the nanoparticles of the small amount of 0.05 wt % are mixed in the liquid crystal layer, the light leakage does not appear.

According to the present exemplary embodiment, the liquid crystal molecules may be vertically aligned by mixing the nanoparticles of the small amount of 0.05 wt % in the liquid crystal layer such that the light leakage generated due to the mixture of a large amount of the nanoparticles in the liquid crystal layer may be prevented in the dark state.

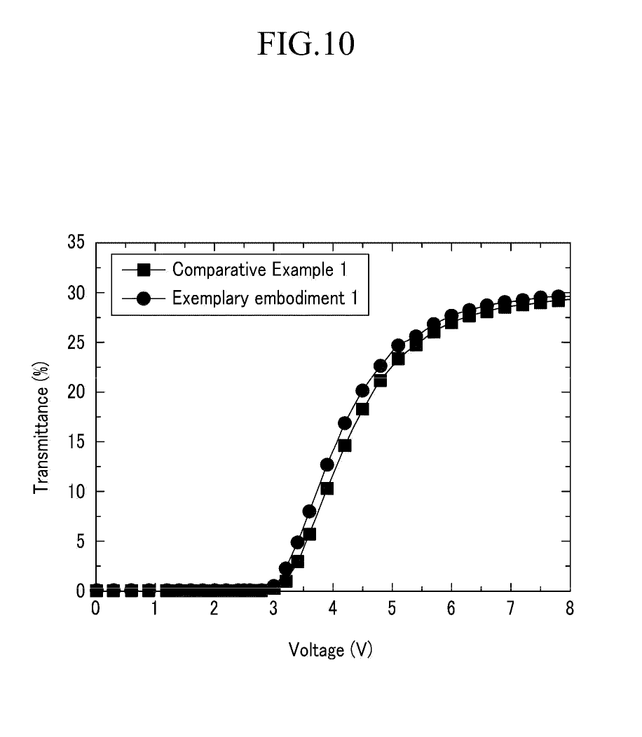

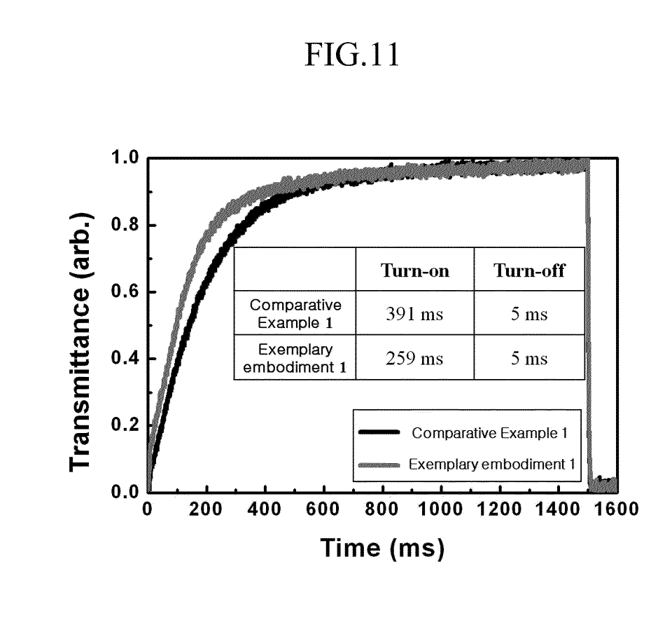

FIG. 10 and FIG. 11 are graphs showing transmittance and response time according to a voltage in Comparative Example 1 and an Exemplary Embodiment 1.

Comparative Example 1 includes the pixel electrode including the minute branches and the vertical alignment layer and a Super Vertical Alignment mode (herein after “SVA” mode) liquid crystal display that does not include the mesogen as the alignment supplement agent is used, and Exemplary Embodiment 1 is the SVA mode liquid crystal display in which the vertical alignment layer is removed from the Comparative Example 1 and the nanoparticles according to the exemplary embodiment of FIG. 7 are mixed in the liquid crystal layer.

Referring to FIG. 10 and FIG. 11, in the case of Exemplary Embodiment 1, the voltage-transmittance characteristic and the response characteristic that are similar to those of Comparative Example 1 using the vertical alignment layer may be obtained. In the case of Exemplary Embodiment 1, the initial pretilt is 90 degrees such that the initial inclination direction is not controlled, thereby the slow turn-on time appears.

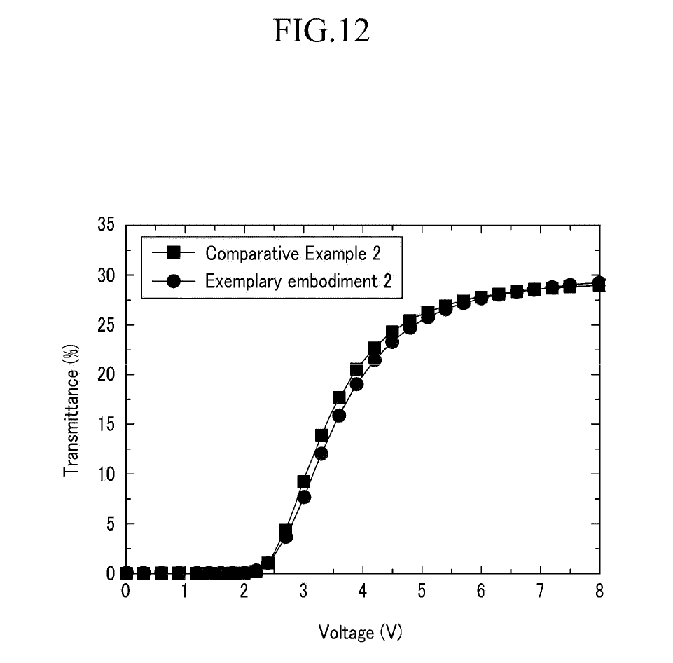

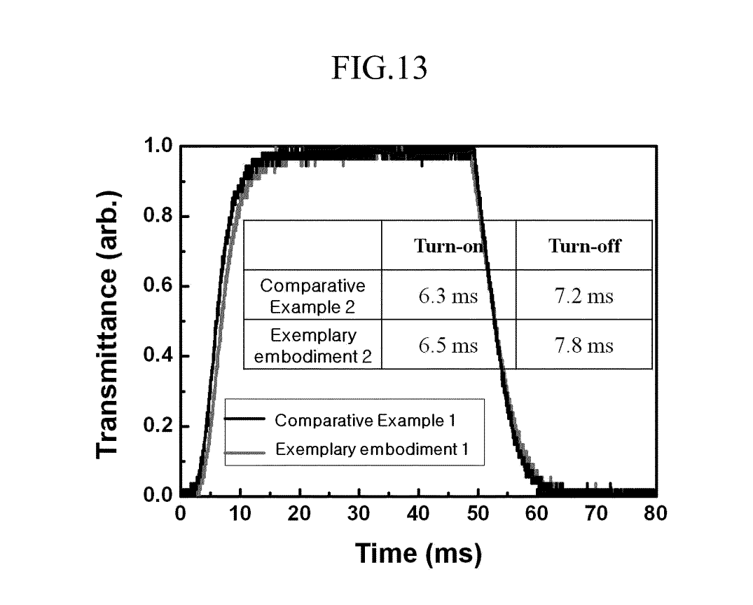

FIG. 12 and FIG. 13 are graphs showing transmittance and response time according to voltage in Comparative Example 2 and Exemplary Embodiment 2.

Comparative Example 2 and Exemplary Embodiment 2 are liquid crystal displays in which the mesogen is added to the liquid crystal layer in the Comparative Example 1 and the Exemplary Embodiment 1.

Referring to FIG. 12 and FIG. 13, in the case of Exemplary Embodiment 2, while having the voltage-transmittance characteristic and the response characteristic similar to Comparative Example 2 using the vertical alignment layer and the mesogen, the improved response speed and turn-on time may be obtained compared with Exemplary Embodiment 1. This is because the pretilt may be formed by the mesogen, and it may be confirmed that the similar characteristic to the liquid crystal display of the conventional SVA mode may be obtained without the vertical alignment layer.

In the exemplary embodiment of FIG. 1 and the exemplary embodiment of FIG. 3, the liquid crystal molecules are vertically aligned without the alignment layer, however, as another exemplary embodiment, the alignment layer may be formed on the pixel electrode or the common electrode. Particularly, in the liquid crystal display of the SVA mode, the mesogen may be included in the alignment layer as well as the liquid crystal layer.

In this exemplary embodiment, the liquid crystal layer is mixed with the nanoparticles such as HTAB and simultaneously includes the alignment layer such that the initial vertical alignment state may be further stable.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

3: liquid crystal layer 12, 22: polarizer
91: storage electrode connection bridge 100, 200: display panel
110, 210: insulation substrate 121: gate line
124: gate electrode 131: storage electrode line
140: gate insulating layer 151, 154: semiconductor
171: data line 173: source electrode
175: drain electrode 180: passivation layer
191: pixel electrode 196-198: cutout
220: light blocking member 230: color filter
250: overcoat 270: common electrode
271-273: cutout 310: liquid crystal molecule

What is claimed is:

1. A liquid crystal display comprising:
a first substrate;
a second substrate facing the first substrate; and
a liquid crystal layer interposed between the first substrate and the second substrate,
wherein the liquid crystal layer includes liquid crystal molecules and nanoparticles including a hydrophobic group having a chain structure and a hydrophilic group.

2. The liquid crystal display of claim 1, wherein
the hydrophobic group having a chain structure include a hydrocarbon chain, wherein the hydrocarbon chain has two end portions, and the hydrophilic group is positioned at one of the two end portions.

3. The liquid crystal display of claim 2, further comprising:
a thin film transistor positioned on the first substrate; and
a field generating electrode connected to the thin film transistor,
wherein the hydrophilic group of the nanoparticle is positioned adjacent to the field generating electrode.

4. The liquid crystal display of claim 3, wherein
the hydrocarbon chain extends substantially vertically to the field generating electrode.

5. The liquid crystal display of claim 4, wherein
the liquid crystal molecules are positioned adjacent to the end portion positioned at an opposite side to the end portion where the hydrophilic group is positioned, and the liquid crystal molecules are vertically aligned in a state that an electric field is not applied to the field generating electrode.

6. The liquid crystal display of claim 1, wherein
the nanoparticles include HTAB (hexadecyl trimethyl ammonium bromide).

7. The liquid crystal display of claim 6, wherein
the nanoparticles are included in a range of equal to or more than about 0.01 wt % and equal to or less than about 0.05 wt % in the liquid crystal layer.

8. The liquid crystal display of claim 1, further comprising:
a field generating electrode positioned on the first substrate; and
an alignment layer positioned between the field generating electrode and the liquid crystal layer.

9. The liquid crystal display of claim 8, wherein
the field generating electrode includes a plurality of minute branches.

10. The liquid crystal display of claim 9, wherein
the alignment layer includes the nanoparticles including the hydrophobic group having the chain structure, and the hydrophilic group.

11. The liquid crystal display of claim 10, wherein
at least one of the liquid crystal layer and the alignment layer further includes an alignment polymer.

12. The liquid crystal display of claim 11, wherein
the nanoparticles included in the at least one of the liquid crystal layer and the alignment layer include the hydrocarbon chain, the hydrocarbon chain has two end portions, and the hydrophilic group is attached to one of the two end portions.

13. The liquid crystal display of claim 12, further comprising:
a thin film transistor positioned on the first substrate; and
a field generating electrode connected to the thin film transistor,
wherein the hydrophilic group of the nanoparticles is positioned adjacent to the field generating electrode.

14. The liquid crystal display of claim 13, wherein
the hydrocarbon chain extends in a direction substantially vertical to the field generating electrode.

15. The liquid crystal display of claim 14, wherein
the liquid crystal molecules are positioned adjacent to the end portion positioned at an opposite side to the end portion where the hydrophilic group is positioned, and the liquid crystal molecules are vertically aligned in a state that an electric field is not applied to the field generating electrode.

16. The liquid crystal display of claim 8, wherein
the nanoparticles include HTAB (hexadecyl trimethyl ammonium bromide).

17. The liquid crystal display of claim 16, wherein
the nanoparticles are included in a range of equal to or more than about 0.01 wt % and equal to or less than about 0.05 wt % in the liquid crystal layer.

18. A liquid crystal display comprising:
a first substrate;
a second substrate facing the first substrate; and
a liquid crystal layer interposed between the first substrate and the second substrate,
wherein the liquid crystal layer includes liquid crystal molecules and nanoparticles represented by Formula 1 below:

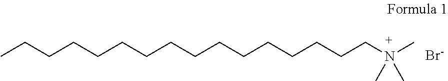

19. The liquid crystal display of claim 18, further comprising:
a thin film transistor positioned on the first substrate;
a field generating electrode connected to the thin film transistor; and
a hydrophilic group of the nanoparticles,
wherein a hydrophilic group of the nanoparticles is positioned adjacent to the field generating electrode.

20. The liquid crystal display of claim 19, further comprising:
a hydrocarbon chain in the nanoparticle,
wherein the hydrocarbon chain in the nanoparticle extends in a direction substantially vertical to the field generating electrode,
wherein the liquid crystal molecules are positioned adjacent to one end of the hydrocarbon chain, and
wherein the liquid crystal molecules are vertically aligned in a state that an electric field is not applied to the field generating electrode.
